(19) United States
(12) Patent Application Publication
(10) Pub. No.: US 2008/0213568 A1
(43) Pub. Date: Sep. 4, 2008

(54) Polyether Polymer Matrix

(75) Inventors: Ib Johannsen, Vaerlose (DK); Patrik Gavelin, Rydebak (SE); Monica R. Gallego, Allerslev (DK)

Correspondence Address: EDWARDS ANGELL PALMER & DODGE LLP, P.O. BOX 55874, BOSTON, MA, 02205, US

(73) Assignee: VERSANATRUX A/S, VALBY (DK)

(21) Appl. No.: 11/661,341

(22) PCT Filed: Aug. 26, 2005
(86) PCT No.: PCT/DK2005/000547

§ 371 Date: Nov. 2, 2007

(30) Foreign Application Priority Data
Aug. 27, 2004 (DK) PA 2004-01295

(51) Int. Cl. C08G 65/18; C08G 65/02; C08F 287/00; B32B 5/16

(52) U.S. Cl. 428/327; 528/425; 528/417; 525/50; 528/392; 528/421

(57) ABSTRACT

The present invention relates to polyether resins, methods for their manufacture and uses thereof. In one aspect of the invention the polyether resin comprises a plurality of functional groups and is obtained by polymerisation of a mixture of alkoxylated reactive compounds selected from a) alkoxylated compounds having a functionality of more than one, and b) alkoxylated monofunctional reactive compounds, wherein the alkoxylated part of the alkoxylated compounds having a functionality of more than one has an average molecular weight which is different from the average molecular weight of the alkoxylated part of the alkoxylated monofunctional reactive compounds.

All patent and non-patent references cited in the application are hereby incorporated by reference in their entirety.

### FIELD OF INVENTION

The present invention relates to polyether resins, methods for their manufacture and uses thereof. In one aspect of the invention the polyether resin comprises a plurality of functional groups and is obtained by polymerisation of a mixture of alkoxylated reactive compounds having one or more functionalities and having different molecular weights.

### BACKGROUND OF INVENTION

Traditionally, polystyrene-divinylbenzene (PS-DVB) has been used as a support for solid phase chemistry because of its high thermal stability, chemical inertness, and mechanical robustness. However, the limited swelling of PS-DVB supports in polar media can limit reagent accessibility and prevent chemical applications in which complete solvation of the polymer matrix is essential for reactivity.

Although increased swelling in polar solvents can be achieved by grafting polyethylene glycol (PEG) to chloromethylated PS-DVB, the resulting PEG-grafted PS-DVB supports such as TentaGel™ (Rapp Polymere GmbH; Tubingen, Germany) and ArgoGel™ (Argonault Technologies; San Carlos, Calif.) have limitations for use in aqueous solvents and for enzymatic chemistry.

Several PEG-based resins exhibit high swelling volumes in both non-polar solvents and water. These resins include, for example, polyoxyethylene-polyoxypropylene (POEPOP), SPOCC (Superior Polymer for Organic Combinatorial Chemistry, a polymer formed by cationic polymerization of a mixture of mono- and bis-oxetanylated PEG macromonomers), and polyoxyethylene-polystyrene (POEPS).

These polymers have a good biocompatibility and chemical stability but are limited in their density of functional handles (loading). These limitations origin from the fact that these polymers are made from partial alkylation of PEG chains, which results in a mixture of unsubstituted PEG, monosubstituted PEG and disubstituted PEG chains, all with the same chain length. The unsubstituted PEG's is an undesired impurity and the fact that all the partially alkylated PEG chains have the same length limits the resulting ratio between loading ad swelling. This ratio corresponds to the loading per volume (mol/l), which has been reported to be 0.05 to 0.08 in water for resins based on PEG macromonomers of 1500 g/mol, and ˜0.3 in water for PEG macromonomers of 400 g/mol. [J. Rademann et al. (1999) J. Am. Chem. Soc 121: 5459-5466]. Also the ratio between mono- and di-functional macromonomers cannot be varied freely since it is controlled by the statistics in the alkylation process of these PEG based macromonomers. In addition, the monosubstituted and the di-substituted chains have to be PEG chains, which would limit the possibility for adapting the hydrophilicity of the chains and thus the swelling in a given solvent mixture.

There is a need for obtaining functional resins with an adjustable loading/swelling ratio for various applications, as well as, resins with higher loadings than the present PEG based resins, while retaining their biocompatibility and high swelling.

### SUMMARY OF INVENTION

The polymer resins of the present invention exhibit several advantageous features which can be exploited in applications such as affinity chromatography, solid-phase organic chemistry, solid-phase enzymatic reactions, and on-bead screening assays.

The present invention in one aspect relates to a resin comprising a polymer matrix having a plurality of functional groups, wherein the matrix can be obtained by polymerisation of a mixture of alkoxylated reactive compounds selected from a) alkoxylated compounds having a functionality of more than one, and b) alkoxylated monofunctional reactive compounds, wherein the alkoxylated part of the alkoxylated compounds having a functionality of more than one, such as alkoxylated di- or oligofunctional alkoxylated compounds, has an average molecular weight which is different from the average molecular weight of the alkoxylated part of the alkoxylated monofunctional reactive compounds. The polymerisation optionally takes place in the presence of a chain extension monomer.

The below scheme illustrates the principle of the polymerisation. Predefined amounts of di- or oligofunctional alkoxylated reactive compounds are mixed with predefined amounts monofunctional alkoxylated reactive compounds, optionally in the presence of a chain extension monomer and the resulting mixture is polymerised under appropriate conditions.

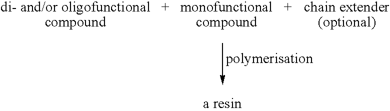

The ratio between the components defines important parameters like swelling and loading. It is a significant advantage that a vide variety of properties can be obtained by adjusting the ratio between as little as three components. In addition the hydrophilicity of the three components can be adjusted individually by selecting different polyethers as the alkoxylated part. This way the swelling behaviour in different solvents can be optimised for specific applications.

The chain extender is preferably a cyclic ether or a vinyl ether, but other chemical entities exhibiting similar reactivities can also be used

The alkoxylated part of the alkoxylated di- or oligofunctional reactive compound and the alkoxylated part of the monofunctional reactive compounds have different molecular weights.

The basic structure of a mono- and a difunctional alkoxylated reactive compound according to the invention is illustrated herein below:

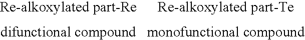

wherein “Re” denotes a reactive group, and wherein “Te” denotes a terminal group different from the reactive group(s).

### DETAILED DESCRIPTION OF THE INVENTION

### Definitions

PEGn are polyethyleneglycols wherein n represents the average molecular weight of the polyethylene glycol, e.g. PEG400 represents a polyethylene glycol with the average molecular weight 400 g/mol. PPGn are polypropyleneglycols wherein n represents the average molecular weight of the polypropylene glycol, e.g. PPG400 represents a polypropylene glycol with the average molecular weight 400 g/mol. Similarly, random and block copolymers are denoted ran-(PEG-PPG)n and block-(PEG-PPG)n wherein n represents the average molecular weight of the copolymer chain, e.g. ran-(PEG-PPG)2500 represents a random copolymer of ethylene glycol and propyleneglycol units with a total average molecular weight of 2500 g/mol.

(EO)ₙ represents n ethylene oxide units in a polymer chain, e.g. (EO)₄ represents 4 ethylene oxide units.

(PO)ₙ represents n propylene oxide units in a polymer chain, e.g. (PO)₅ represents 5 ethylene oxide units.

### Alkoxylated Reactive Compounds

In one embodiment the alkoxylated reactive compounds can be selected from ethoxylated reactive compounds and propoxylated reactive compounds, including a combination of both ethoxylated reactive compounds and propoxylated reactive compounds.

The alkoxylated reactive compounds are typically selected from alkoxylated glycidol, oxetane, ethenyl ether and 1-propenyl ether, including any combination thereof.

The alkoxylated di- or oligofunctional reactive compounds may be selected from polyethylene glycol bis(3-methyloxetane-3-methyl)ether, polyethylene glycol bis(3-ethyloxetane-3-methyl)ether, ethoxylated trimethylolpropane tris(3-methyloxetane-3-methyl)ether, ethoxylated pentaerythritol tetrakis(3-methyl-oxetane-3-methyl)ether, polyethylene glycol diglycidyl ether, and triethylene glycol divinyl ether, including any combination thereof.

Examples of alkoxylated di- or oligofunctional reactive compounds are those selected from ethers of monodisperse or polydisperse polyethyleneglycols (PEGs) having the general formula PEGn, wherein n represents the average molecular weight (g/mol) of the polyethylene glycol, such as ethers of monodisperse or polydisperse polyethyleneglycols having an average molecular weight (g/mol) in the range of from 60 to preferably less than 8000, such as polyethylene glycols in the range of from PEG100 to PEG8000, for example PEG100 to PEG400, such as PEG400 to PEG1000, for example PEG1000 to PEG2000, such as PEG2000 to PEG4000, for example PEG4000 to PEG8000.

Alternative examples of alkoxylated di- or oligofunctional reactive compounds are those selected from ethers of monodisperse or polydisperse polypropyleneglycols (PPGs) having the general formula PPGn, wherein n represents the average molecular weight (g/mol) of the polypropylene glycol, such as ethers of monodisperse or polydisperse polypropyleneglycols having an average molecular weight (g/mol) in the range of from 70 to preferably less than 8000, such as polypropylene glycols in the range of from PPG70 to PPG8000, for example PPG120 to PPG400, such as PPG400 to PPG1000, for example PPG1000 to PPG2000, such as PPG2000 to PPG4000, for example PPG4000 to PPG8000.

Still further alternative examples of alkoxylated di- or oligofunctional reactive compounds are those selected from ethers of monodisperse or polydisperse random or block co-polymers of ethyleneglycol and propyleneglycol units (PEG-PPG) having the general formula (PEG-PPG)n, wherein n represents the average molecular weight (g/mol) of the copolymer chain, such as ethers of monodisperse or polydisperse block or random co-polymers having an average molecular weight (g/mol) in the range of from 110 to preferably less than 8000, such as random polyethylene poly propylene glycols in the range of from (PEG-PPG)110 to (PEG-PPG)8000, for example (PEG-PPG)110 to (PEG-PPG)400, such as (PEG-PPG)400 to (PEG-PPG)1000, for example (PEG-PPG)1000 to (PEG-PPG)2000, such as (PEG-PPG)2000 to (PEG-PPG)4000, for example (PEG-PPG)4000 to (PEG-PPG)8000.

In one preferred embodiment, alkoxylated compounds having a functionality of more than one are difunctional alkoxylated compounds. In another embodiment, alkoxylated compounds having a functionality of more than one are oligofunctional alkoxylated compounds having a functionality of more than 2.

It is preferred that the alkoxylated compounds having a functionality of more than one has a number of alkoxylene oxide units of at least 6 such as at least 8, e.g. at least 10.

Examples of alkoxylated difunctional reactive compounds are polydisperse PEG400 bis(3-methyloxetane-3-methyl)ether, polydisperse PEG1000 bis(3-methyloxetane-3-methyl)ether, polydisperse PEG1000 bis(3-methyloxetane-3-ethyl)ether, polydisperse PEG2000 bis(3-methyloxetane-3-methyl)ether, polydisperse PEG4000 bis(3-methyloxetane-3-methyl)ether, polydisperse PPG400 bis(3-methyloxetane-3-methyl)ether, polydisperse PPG2000 bis(3-methyloxetane-3-methyl)ether, polydisperse ran-(PEG-PPG)2000 bis(3-methyloxetane-3-methyl)ether, and polydisperse tri-block-(PEG-PPG-PEG)1900 bis(3-methyloxetane-3-methyl)ether.

The alkoxylated monofunctional reactive compounds can be selected from alkoxylated glycidols, oxetanes, ethenyl ethers, and 1-propenyl ether, including any combinations thereof. Examples include tetraethyleneglycol monoglycidyl ether and 4-hydroxybutyl vinyl ether.

In one preferred embodiment, the alkoxylated monofunctional reactive compounds are selected from the group consisting of ethoxylated oxetanes and propoxylated oxetanes, including any combination of ethoxylated oxetanes and propoxylated oxetanes.

Preferably, the ethoxylated monofunctional oxetane compounds are selected from polydisperse ethoxylated monofunctional oxetane compounds having from 2 to 30 ethylene oxide units, such as (EO)₂₋₃₀ oxetane, such as (EO)₃ oxetane, (EO)₆ oxetane, (EO)_{g} oxetane, (EO)₁₂ oxetane and (EO)₁₅ oxetane, including any combination thereof.

Likewise, the propoxylated monofunctional oxetane compounds can preferably be selected from polydisperse propoxylated monofunctional oxetane compounds having from 2 to 30 propylene oxide units, such as (PO)₂₋₃₀ oxetane, such as (PO)₃ oxetane, (PO)₆ oxetane, (PO)_{g} oxetane, (PO)₁₂ oxetane or (PO)₁₅ oxetane.

Preferred oxetanes are 3-methyloxetane-3-methanol and 3-ethyloxetane-3-methanol.

In one embodiment, the polydisperse alkoxylated monofunctional reactive compounds can comprise or consist of compounds having the formulas illustrated herein below:

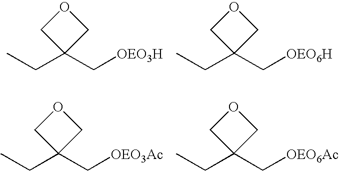

Such 3-ethyloxetanes are believed to provide advantageous properties with respect to a slightly lower reactivity than the corresponding 3-methyloxetanes.

### Terminal Groups

The terminal groups of the monofunctional reactive compounds can be any suitable terminal group, including groups such as e.g. hydroxyl, ester, ether, amide, azido, and leaving groups, including any combination thereof.

The terminal group of the monofunctional reactive compound can also be an ester, such as formate, acetate, propanoate, butanoate, i-butanoate, trifluoroacetate, benzoate, methylbenzoate, or nitrobenzoate; or the terminal group of the monofunctional reactive compound can be an ether, such as e.g. methyl, ethyl, propyl, butyl, hexyl, dodecyl, allyl, butenyl, benzyl, substituted benzyl such as methylbenzyl or nitrobenzyl; or t-butyldimethylsilyl; or the terminal group of the monofunctional reactive compound can be a carboxamido, such as formamido, acetamido, propanamido, trifluoroacetamido, benzamido, substituted benzamido such as methylbenzamido or nitrobenzamido; phthalimido, succinimido, sulfonamido such as p-toluenesulfonamido or trifluorosulfonamido; or the terminal group of the monofunctional reactive compound can be a leaving group, such as chloro, bromo, iodo, or sulphonate such as methanesulfonate, p-toluenesulfonate, or trifluoromethanesulfonate.

### Chain Extension Monomer

In one embodiment, the polymerisation of the mixture of alkoxylated reactive compounds takes place in the presence of a chain extension monomer. The chain extension monomer may, e.g., be a cyclic ether or a vinyl ether.

When the chain extension monomer comprises or consists of a cyclic ether, examples include, but is not limited to epoxides, oxetanes, and tetrahydrofuranes.

The epoxide can be selected from ethylene oxide, propylene oxide, 1,2-butene oxide, 2,3-butene oxide, cyclohexene oxide, limonene oxide and styrene oxide, including any combination thereof.

In some embodiments, the epoxide can be a glycidol, or a glycidyl ether, such as allyl glycidyl ether, or phenyl glycidyl ether. The epoxide can also comprise or consist of a carbohydrate epoxide.

The oxetane can e.g. be 1,3-trimethylene oxide, 3,3-dimethyloxetane, 3-(bromomethyl)-3-methyl oxetane, or 3-ethyl-3-(hydroxymethyl)oxetane.

The tetrahydrofurane can e.g. be 1,4-butylene oxide.

### Loading Capacities and Swelling Volumes

The loading of functional groups is preferably in the range of from 0.01 to 5 mmol/g, such as in the range of from 0.5 to 3 mmol/g, for example in the range of from 1.0 to 2 mmol/g. The loading values depend among other things on the ratio between the alkoxylated monofunctional reactive compounds and the alkoxylated di- or oligofunctional reactive compounds. Thus, high loading values are obtained when the polymerisation mixture contains high relative amounts of monofunctional reactive compounds.

The swelling in an aqueous liquid, including water, can be in the range of 1 mL/g to 30 mL/g, such as from 3 mL/g to 20 mL/g, for example from 3 mL/g to 15 mL/g, such as from 5 mL/g to 10 mL/g.

In general high loading/swelling ratios or loading per volume resin swelled in aqueous liquid, including water, can be in the range of 0.1 mmol/mL to 20 mmol/mL, such as from 0.2 mmol/mL to 10 mmol/mL, for example from 0.3 mmol/mL to 5 mmol/mL.

The amount of PPG relative to the amount of PEG in the resins has a strong impact on the swelling behaviour in water and organic solvents. High PEG contents result in resins with high water swelling and low swelling in non-polar organic solvents. Inversely, high PPG contents give higher swelling in organic solvents than in water.

Thus, the swelling behaviour can be adapted to give a desired solvent dependency of swelling. The PPG/PEG ratio can be controlled by mixing PPG and PEG containing reactive compounds or by using copolymers of PPG and PEG or a combination of these.

### Composition of Beaded and Cross-Linked Polymer Matrices

There is also provided a composition comprising a plurality of beaded, cross-linked polymer matrices according to the invention. The average bead diameter is preferably in the range of 0.01 μm to 1500 μm, such as from 10 to 1000 μm, for example from 100 to 500 μm.

### Methods for Generating Polymer Matrices According to the Invention

There is provided a method for generating a cross-linked and optionally beaded resin according to the invention, or a composition according to the invention as described herein above and in the examples.

### The Method Comprises the Steps of

providing a mixture of alkoxylated reactive compounds selected from a) alkoxylated compounds having a functionality of more than one, and b) alkoxylated monofunctional reactive compounds, wherein the alkoxylated part of the alkoxylated compounds having a functionality of more than one has an average molecular weight which is different from the average molecular weight of the alkoxylated part of the alkoxylated monofunctional reactive compounds, optionally in the presence of a chain extender,
polymerizing the mixture of alkoxylated reactive compounds,
wherein said polymerization optionally proceeds under beading conditions and leads to the formation of a polymer resin according to the present invention, preferably a beaded polymer resin.

The method can be performed as a batch or continuous process. A chain extension monomer can be provided, as can an initiator or catalyst, as well as a radiation or thermally curing component.

The mixture of alkoxylated reactive compounds can be mixed with the initiator in specific ratios, preferably in a solvent and under beading conditions. Preferably, the mixture of alkoxylated reactive compounds is mixed with a solvent to form a dispersed phase and subsequently poured into a continuous phase with stirring. A surface active agent can also be added to the reactive phase or to the continuous phase, or to both.

The ratio of mole equivalents of di- or oligofunctional reactive compounds to monofunctional reactive compounds can be from 1:0.1 to 20, such as 1:1-15, for example 1:2-12.

The ratio of mole equivalents of di- or oligofunctional reactive compounds to monofunctional reactive compounds to chain extension monomer can be in the range of 1:0.1-20:0-10; such as 1:1-15:0-5; for example 1: 2-12:0-1.

The reaction can be run neat or in the presence of a solvent, such as a halogenated solvent, for example methylene chloride, chloroform, carbon tetrachloride, or an aromatic solvent for example toluene, xylene, chlorobenzene or nitrobenzene, or an ether solvent for example tetrahydrofurane, dioxane, dimethoxyethane, diethyleneglycol dimethyl ether, triethylene glycol dimethyl ether, or tetraethyleneglycol dimethyl ether; nitrile for example acetonitrile or propionitrile, and an ester such as methyl formate, dimethyl carbonate, or ethylene carbonate.

The concentration of reactive compounds in the reaction solution is typically from 5 to 100%, such as from 10 to 70%, for example from 15 to 50%.

The reaction temperature can be anything suitable, typically it is in the range of from −20° C. to 100° C., such as from 0° C. to 70° C., for example from 10° C. to 40° C.

The catalyst for the polymerisation can be a Lewis acid, a Brønsted acid, a cationic salt, or precursors thereof. The Lewis acid can be e.g. zinc trifluoromethanesulfonate, aluminium chloride, boron trifluoride ethyl etherate or boron trifluoride-tetrahydrofurane complex. The Brønsted acid or a precursor thereof can be e.g. trifluoromethanesulfonic acid, trimethylsilyl trifluoromethanesulfonate, p-toluenesulfonic acid, 2,4,6-triisopropylbenzenesulfonic acid, pentafluorobenzenesulfonic acid, perchloric acid, and tetrafluoroboric acid. The cationic salt can be e.g. a sulfonium salt, an iodonium salt, or an ammonium salt of hexafluorophosphoric acid, hexafluoroantomony acid, and tetrakis(pentafluorophenyl)boric acid. The sulfonium salt can be e.g. trifenylsulfonium or S-benzyltetrathiophenium, such as S-(p-methoxybenzyl)-tetrahydrothiophenium or S-(p-nitrobenzyl)tetrathiophenium. The iodonium salt can comprise or consist of diphenyliodonium. The ammonium salt can comprise or consist of N-benzyl-N,N-dimethylanilinium or pyridinium.

When the polymer matrix is in a beaded form, the beaded polymer matrix can be obtained by inverse suspension or inverse emulsion polymerisation. The beading process can utilise a combination of liquid phases, a reactive phase and a continuous phase, and optionally also a surface active agent. The reactants are preferably dissolved in the reactive phase and added to the continuous phase with stirring.

The catalyst and the surfactant, when present, can be added either to the reactive phase, before being added to the continuous phase, or to the continuous phase before or after the reactive phase has been added.

The reactive phase can be a polar solvent, such as an ether solvent, for example tetrahydrofurane, dioxolane, dioxane, dimethoxyethane, diethyleneglycol dimethyl ether, triethylene glycol dimethyl ether, or tetraethyleneglycol dimethyl ether. The reactive phase can also be a polar solvent such as a nitrile, for example acetonitrile or propionitrile. The reactive phase can also be a polar solvent such as a ketone, for example acetone, including any combination thereof. The reactive phase can also be a polar solvent such as an ester, for example methyl formate, methyl acetate, ethyl formate, dimethyl carbonate, or ethylene carbonate, including any combination thereof.

The continuous phase can be a petroleum fraction, an aliphatic oil, a silicon oil, a natural fat or triglyceride, an aromatic solvent, such as toluene or xylene, a halogenated solvent such as methylene chloride, chloroform, carbon tetrachloride, dichloroethane, trichloroethylene, chlorobenzene, and a fluorinated solvent, including any combination thereof.

The ratio of reactive phase to non-miscible liquid is typically from 2:1 to 1:100, for example from 4:5 to 1:75, such as from 1:2 to 1:30.

The surface active agent can be selected from the group consisting of neutral surface active agents, such as ethoxylated aliphatic alcohols, ethoxylated alkylphenols, alkylphenols, carbohydrate derived esters, e.g., sorbitan laurate; amphiphilic polymers such as copolymers of polyethylene glycol methacrylate and lauryl acrylate or trialkylsilylalkyl methacrylate, or copolymers of ethylene oxide and propylene oxide, or homopolymers such as polyvinyl acetate, or completely or partially hydrolysed polyvinyl acetate, or combinations thereof.

The stirring frequency can be anything suitable, typically from 1 to 2000 rpm, such as 50 to 1000 rpm, or 100 to 500 rpm.

### Uses of the Polymer Resins According to the Invention

A number of uses of a resin or composition according to the present invention are also provided, including:

Use of the resin according to the invention or the composition according to the invention for scavenging undesirable chemical compounds, preferably carbonyl and/or sulfonyl compounds, from a composition comprising a mixture of chemical entities.

Use of the resin according to the invention or the composition according to the invention as support for immobilised reagents such as oxidizing agents, or alkylating agents, or complexing agents, such as phosphines.

Use of the resin according to the invention or the composition according to the invention for scavenging undesirable chemical compounds, preferably carbonyl and/or sulfonyl compounds, from a composition comprising a mixture of chemical entities. The undesirable chemical compounds can be generated in any type of reactions, including organometallic reactions. The carbonyl or sulfonyl compounds are preferably selected from the group of compounds consisting of organic acids, acid chlorides, sulfonyl chlorides, ketones, aldehydes, and derivatives thereof.

Use of the resin according to the invention or the composition according to the invention for scavenging off-flavour related carbonyl compounds from a fermented product, or a drinkable composition comprising a fermented product. The carbonyl compounds can be dicarbonyl compounds, and the fermented product can be beer or cider or wine.

Use of the resin according to the invention or the composition according to the invention as support for the synthesis of an organic molecule.

Use of the resin according to the invention or the composition according to the invention as supports when generating a combinatorial chemistry library.

Use of the resin according to the invention or the composition according to the invention as supports when generating a library of chemical entities.

Use of the resin according to the invention or the composition according to the invention as a support for the synthesis of a drug molecule, a peptide, a protein, DNA, or RNA.

Use of the resin according to the invention or the composition according to the invention as support for solid phase enzyme reactions.

Use of the resin according to the invention or the composition according to the invention for protein immobilisation of biomolecules, such as proteins, enzymes, or other biochemically active entities.

Use of the resin according to the invention or the composition according to the invention for chromatographic separation or purification of desirable target compounds including affinity purification.

### EXAMPLES

### Example 1

The beaded polymer resin was prepared by an inverse suspension polymerization method. To a flask containing 15 mL of acetonitrile, 10.0 g of bis(3-methyloxetane-3-methyloxetane-3-methyl)ether polyethylene glycol (MₙPEG=400 g/mol) having an average molecular weight of ˜570 g/mol and 20.0 g acetylated trimethylolpropane oxetane ethoxylate (composed of three ethylene oxide units in average) (MW=290 g/mol) were added. Following this, 0.60 g of a surfactant was added and dissolved in the reaction mixture. The reaction mixture (dispersed phase) was cooled to below −10° C. The initiator, 1.87 g boron trifluoride ethyl etherate, was added drop wise under controlled temperature, not exceeding −10° C. After the addition, the solution was added to the continuous phase, consisting of 600 mL of paraffin oil in a three-necked baffled flask, equipped with a mechanical stirrer, forming a suspension of beads. The chemical synthesis, i.e. network formation, was performed at 30° C. for 20 h. After the polymerization, the resulting beads were filtrated from the oil phase. The beads were then sequentially washed with dichloromethane, tetrahydrofurane, methanol and water to remove rest products and oil. The beads were treated with 4 M HCl for 2 h at 60° C. and 4 M NaOH for 2 h at 60° C., followed by washing with dichloromethane, methanol and water. The degree of hydroxyl functionality (hydroxyl capacity, loading) was analyzed to 2.5 mol/kg. The swelling performance in water was determined to 2.2 mL/g. Thus, the loading per volume was determined to 1.1 mmol/mL.

### Example 2

The beaded polymer resin was prepared by an inverse suspension polymerization method. To a flask containing 15 mL of acetonitrile, 19.8 g of bis(3-methyloxetane-3-methyloxetane-3-methyl)ether polyethylene glycol (MₙPEG=400 g/mol) having an average molecular weight of ˜570 g/mol and 10.2 g acetylated trimethylolpropane oxetane ethoxylate (composed of three ethylene oxide units in average) (MW=290 g/mol) were added. Following this, 0.60 g of a surfactant was added and dissolved in the reaction mixture. The reaction mixture (dispersed phase) was cooled to below −10° C. The initiator, 1.89 g boron trifluoride ethyl etherate, was added drop wise under controlled temperature, not exceeding −10° C. After the addition, the solution was added to the continuous phase, consisting of 600 mL of paraffin oil in a three-necked baffled flask, equipped with a mechanical stirrer, forming a suspension of beads. The chemical synthesis, i.e. network formation, was performed at 30° C. for 20 h. After the polymerization, the resulting beads were filtrated from the oil phase. The beads were then sequentially washed with dichloromethane, tetrahydrofurane, methanol and water to remove rest products and oil. The beads were treated with 4 M HCl for 2 h at 60° C. and 4 M NaOH for 2 h at 60° C., followed by washing with dichloromethane, methanol and water. The degree of hydroxyl functionality (hydroxyl capacity, loading) was analyzed to 1.6 mol/kg. The swelling performance in water was determined to 2.0 mL/g. Thus, the loading per volume was determined to 0.8 mmol/mL.

### Example 3

The beaded polymer resin was prepared by an inverse suspension polymerization method. To a flask containing 15 mL of acetonitrile, 19.0 g of bis(3-ethyloxetane-3-methyloxetane-3-methyl)ether polyethylene glycol (MₙPEG=500 g/mol) having an average molecular weight of ˜742 g/mol and 11.0 g acetylated trimethylolpropane oxetane ethoxylate (composed of three ethylene oxide units in average) (MW=290 g/mol) were added. Following this, 0.60 g of a surfactant was added and dissolved in the reaction mixture. The reaction mixture (dispersed phase) was cooled to below −10° C. The initiator, 3.19 g boron trifluoride ethyl etherate, was added drop wise under controlled temperature, not exceeding −10° C. After the addition, the solution was added to the continuous phase, consisting of 600 mL of paraffin oil in a three-necked baffled flask, equipped with a mechanical stirrer, forming a suspension of beads. The chemical synthesis, i.e. network formation, was performed at 30° C. for 20 h. After the polymerization, the resulting beads were filtrated from the oil phase. The beads were then sequentially washed with dichloromethane, tetrahydrofurane, methanol and water to remove rest products and oil. The beads were treated with 4 M HCl for 2 h at 60° C. and 4 M NaOH for 2 h at 60° C., followed by washing with dichloromethane, methanol and water. The degree of hydroxyl functionality (hydroxyl capacity, loading) was analyzed to 2.0 mol/kg. The swelling performance in water was determined to 2.0 mL/g. Thus, the loading per volume was determined to 1.0 mmol/mL.

### Example 4

The beaded polymer resin was prepared by an inverse suspension polymerization method. To a flask containing, 1.31 g of melted bis(3-methyloxetane-3-methyloxetane-3-methyl)ether polyethylene glycol (MₙPEG=2000 g/mol) having an average molecular weight of ˜2205 g/mol, 1.33 mL of tetraethyleneglycol dimethyl ether was added. Keeping the temperature at 28-30° C., 0.69 g of acetylated trimethylolpropane oxetane ethoxylate (composed of three ethylene oxide units in average) (MW=290 g/mol) was added. The initiator, 0.101 g boron trifluoride ethyl etherate, was added drop wise under a controlled temperature interval of 28-30° C. After the addition, the solution was added to a three-necked baffled flask equipped with a mechanical stirrer, containing the continuous phase that was consisting of 40 mL of paraffin oil and 0.010 g of a surfactant. The chemical synthesis, i.e. network formation, was performed at 40° C. for 20 h. After the polymerization, the resulting beads were filtrated from the oil phase. The beads were then sequentially washed with dichloromethane, tetrahydrofurane, methanol and water to remove rest products and oil. The beads were treated with 4 M HCl for 2 h at 60° C. and 4 M NaOH for 2 h at 60° C., followed by washing with dichloromethane, methanol and water. The degree of hydroxyl functionality (hydroxyl capacity, loading) was analyzed to 1.6 mol/kg. The swelling performance in water was determined to 7.3 mL/g. Thus, the loading per volume was determined to 0.2 mmol/mL.

### Example 5

The beaded polymer resin was prepared by an inverse suspension polymerization method. To a flask containing 2.5 ml of dimethyl carbonate, 2.56 g melted bis(α,ω-3-methyloxetane-3-methyl)ether polyethylene glycol (MₙPEG=2000 g/mol) having an average molecular weight of ˜2205 g/mol and 2.44 g acetylated trimethylolpropane oxetane ethoxylate (composed of 12 ethylene oxide units in average) (MW=686 g/mol) were added. The reaction mixture (dispersed phase) was cooled to 22° C. The initiator, 0.073 g boron trifluoride ethyl etherate, was added to a beaker containing a solution of 0.026 g of trimethylol propane and 0.5 ml dimethyl carbonate. The initiator solution was added drop wise to the dispersed phase under controlled temperature, not exceeding 25° C. After the addition, the solution was added to a three-necked baffled flask equipped with a mechanical stirrer, containing the continuous phase that was consisting of 100 ml of paraffin oil and 0.100 g of a dissolved surfactant. The chemical synthesis, i.e. network formation, was performed at 40° C. overnight. After the polymerization, the resulting beads were filtrated from the oil phase. The beads were then sequentially washed with dichloromethane, tetrahydrofurane, methanol and water to remove rest products and oil. The beads were treated with 4 M HCl for 2 h at 60° C. and 4 M NaOH for 2 h at 60° C., followed by neutralisation and washing with water. The degree of hydroxyl functionality (loading) was analysed to 0.98 mol/kg. The swelling performance in water was determined to 6.3 ml/g. Thus, the loading per volume was determined to 0.156 mmol/ml.

### Example 6

The beaded polymer resin was prepared by an inverse suspension polymerization method. To a flask containing 50 ml of dimethyl carbonate, 58.5 g of bis(α,ω-3-methyloxetane-3-methyl)ether polyethylene glycol/polypropylene glycol (MₙPEG/PPG=1060 g/mol, composed of three polypropylene oxide units in average in a block copolymer structure containing 87 percent PEG, PEG/PPG/PEG, supplied by Ineos—product ID: TB12087) having an average molecular weight of ˜1240 g/mol and 41.5 g acetylated trimethylolpropane oxetane ethoxylate (composed of three ethylene oxide units in average) (MW=290 g/mol) were added. The reaction mixture (dispersed phase) was cooled to 16° C. The initiator, 2.952 g boron trifluoride ethyl etherate, was added to a beaker containing a solution of 1.065 g of trimethylol propane and 10 ml dimethyl carbonate. The initiator solution was added drop wise to the dispersed phase under controlled temperature, not exceeding 25° C. After the addition, the solution was added to a three-necked baffled flask equipped with a mechanical stirrer, containing the continuous phase that was consisting of 500 ml of paraffin oil and 0.75 g of a dissolved surfactant. The chemical synthesis, i.e. network formation, was performed at 40° C. for 2 h. After the polymerization, the resulting beads were filtrated from the oil phase. The beads were then sequentially washed with dichloromethane, tetrahydrofurane, methanol and water to remove rest products and oil. The beads were treated with 4 M HCl for 2 h at 60° C. and 4 M NaOH for 2 h at 60° C., followed by neutralisation and washing with water. The degree of hydroxyl functionality (loading) was analysed to 1.66 mol/kg. The swelling performance in water was determined to 3.0 ml/g. Thus, the loading per volume was determined to 0.55 mmol/ml.

### Example 7

### Polymerization of Phthalimide Resin

The beaded polymer resin was prepared by an inverse suspension polymerization method. To a flask containing 18 ml of dimethyl carbonate, 15.6 g of melted bis(α,ω-3-methyloxetane-3-methyl)ether polyethylene glycol (MₙPEG=2000 g/mol) having an average molecular weight of ˜2205 g/mol. Keeping the temperature at 28-30° C., 14.5 g phthalimide end capped trimethylolpropane oxetane ethoxylate (composed of nine ethylene oxide units in average) (MW=627 g/mol) were added. The reaction mixture (dispersed phase) was cooled to 20° C. The initiator, 0.504 g boron trifluoride ethyl etherate, was added to a beaker containing a solution of 0.161 g of trimethylol propane and 2 ml dimethyl carbonate. The initiator solution was added drop wise to the dispersed phase under controlled temperature, not exceeding 25° C. After the addition, the solution was added to a three-necked baffled flask equipped with a mechanical stirrer, containing the continuous phase that was consisting of 600 ml of paraffin oil and 0.153 g of a dissolved surfactant. The chemical synthesis, i.e. network formation, was performed at 40° C. for 20 h. After the polymerization, the resulting beads were filtrated from the oil phase. The beads were then sequentially washed with dichloromethane, tetrahydrofurane, methanol and water to remove rest products and oil.

### Example 8

### Hydrolysis of Phthalimide Resin

The resin was washed in a glass filter funnel with 150 ml methanol followed by the washing with 150 ml butanol. After draining off the solvent, another 50 ml of butanol was added to the beaker and left at room temperature for 2 h. The butanol was drained off and the resin was placed in a round bottom flask. To the resin, 11 ml of ethylene diamine was added followed by the addition of 30 ml of butanol. The mixture was stirred and heated to 90° C. for 15 h under inert atmosphere. The resultant product was washed with water followed by 0.5 M HCl until the pH was approx. 1-2. The resin was then drain from solvent and covered with 2 M HCl. The mixture was stirred and heated to 90° C. for 2 h. Finally, the resin was washed thoroughly with 1 M NaOH followed by water. The density of amine functionalities (loading) was analysed to 0.43 mol/kg. The swelling performance in water was determined to 7.8 ml/g. Thus, the loading per volume was determined to 0.055 mmol/ml.

1. A resin comprising a polymer matrix comprising a plurality of functional groups, wherein said polymer matrix is obtainable by polymerisation of a mixture of alkoxylated reactive compounds selected from a) alkoxylated compounds having a functionality of more than one, and b) alkoxylated monofunctional reactive compounds, wherein the alkoxylated part of the alkoxylated compounds having a functionality of more than one has an average molecular weight which is different from the average molecular weight of the alkoxylated part of the alkoxylated monofunctional reactive compounds.

2. The resin according to claim 1, wherein the alkoxylated compounds having a functionality of more than one are alkoxylated di- or oligofunctional reactive compounds which are selected from polyethylene glycol bis(3-methyloxetane-3-methyl)ether, polyethylene glycol bis(3-ethyloxetane-3-methyl)ether, ethoxylated trimethylolpropane tris(3-methyloxetane-3-methyl)ether, ethoxylated pentaerythritol tetrakis(3-methyl-oxetane-3-methyl)ether, polyethylene glycol diglycidyl ether, and triethylene glycol divinyl ether, including any combination thereof.

3. The resin according to claim 1, wherein the alkoxylated compounds having a functionality of more than one are alkoxylated di- or oligofunctional reactive compounds which are selected from ethers of monodisperse or polydisperse polyethyleneglycols (PEGS) having the general formula PEGn, wherein n represents the average molecular weight (g/mol) of the polyethylene glycol.

4. The resin according to claim 1, wherein the alkoxylated compounds having a functionality of more than one are alkoxylated di- or oligofunctional reactive compounds which are selected from ethers of monodisperse or polydisperse polypropyleneglycols (PPGs) having the general formula PPGn, wherein n represents the average molecular weight (g/mol) of the polypropylene glycol.

5. The resin according to claim 1, wherein the alkoxylated compounds having a functionality of more than one are alkoxylated di- or oligofunctional reactive compounds which are selected from ethers of monodisperse or polydisperse random or block co-polymers of ethyleneglycol and propyleneglycol units (PEG-PPG) having the general formula (PEG-PPG)n, wherein n represents the average molecular weight (g/mol) of the copolymer chain.

6. The resin according to claim 3, wherein the alkoxylated difunctional reactive compounds are selected from the group consisting of polydisperse PEG400 bis(3-methyloxetane-3-methyl)ether, polydisperse PEG1000 bis(3-methyloxetane-3-methyl)ether, polydisperse PEG1500 bis(3-methyloxetane-3-methyl)ether, polydisperse PEG2000 bis(3-methyloxetane-3-methyl)ether, polydisperse PEG3000 bis(3-methyloxetane-3-methyl)ether, polydisperse PEG4000 bis(3-methyloxetane-3-methyl)ether, polydisperse PPG400 bis(3-methyloxetane-3-methyl)ether, polydisperse PPG2000 bis(3-methyloxetane-3-methyl)ether, polydisperse ran-(PEG-PPG)2500 bis(3-methyloxetane-3-methyl)ether, and polydisperse tri block-(PEG-PPG-PEG)1900 bis(3-methyloxetane-3-methyl)ether, including any combinations thereof.

7. The resin according to claim 1, wherein the alkoxylated monofunctional reactive compounds are selected from tetraethyleneglycol monoglycidyl ether and 4-hydroxybutyl vinyl ether.

8. The resin according to claim 1, wherein the alkoxylated monofunctional reactive compounds are selected from the group consisting of ethoxylated oxetanes and propoxylated oxetanes, including any combination of ethoxylated oxetanes and propoxylated oxetanes.

9. The resin according to claim 8, wherein the ethoxylated monofunctional oxetane compounds are selected from polydisperse ethoxylated monofunctional oxetane compounds having from 2 to 30 ethylene oxide units, such as (EO)₂₋₃₀ oxetane, such as (EO)₃ oxetane, (EO)₆ oxetane, (EO)₉ oxetane, (EO)₁₂ oxetane or (EO)₁₅ oxetane, including any combination thereof.

10. The resin according to claim 8, wherein the propoxylated monofunctional oxetane compounds are selected from polydisperse propoxylated monofunctional oxetane compounds having from 2 to 30 propylene oxide units, such as (PO)₂₋₃₀ oxetane, such as (PO)₃ oxetane, (PO)₆ oxetane, (PO)₉ oxetane, (PO)₁₂ oxetane or (PO)₁₅ oxetane.

11. The resin according to claim 8, wherein the oxetane is selected from 3-methyloxetane-3-methanol and 3-ethyloxetane-3-methanol, including a combination of both.

12. The resin according to claim 1, wherein the alkoxylated monofunctional reactive compound comprises or consists of polydisperse

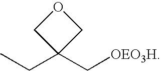

13. The resin according to claim 1, wherein the alkoxylated monofunctional reactive compound comprises or consists of polydisperse

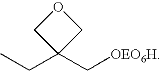

14. The resin according to claim 1, wherein the alkoxylated monofunctional reactive compound comprises or consists of polydisperse

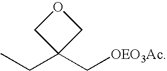

15. The resin according to claim 1, wherein the alkoxylated monofunctional reactive compound comprises or consists of polydisperse

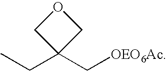

16. The resin according to claim 1, wherein the loading of functional groups is in the range of 0.5 to 3 mmol/g.

17. The resin according to claim 1, wherein the swelling in an aqueous liquid, including water, is in the range of 2 mL/g to 20 mL/g.

18. A composition comprising a plurality of beaded, cross-linked polymer matrices according to claim 1, wherein the average bead diameter is in the range of 0.01 μm to 1500 μm.

19. A method for generating a cross-linked and optionally beaded resin according to claim 1 or the composition according to claim 1, said method comprising the steps of:
a) providing a mixture of alkoxylated reactive compounds selected from a) alkoxylated compounds having a functionality of more than one, and b) alkoxylated monofunctional reactive compounds, wherein the alkoxylated part of the alkoxylated compounds having a functionality of more than one has an average molecular weight which is different from the average molecular weight of the alkoxylated part of the alkoxylated monofunctional reactive compounds,
b) polymerizing the mixture of alkoxylated reactive compounds, and
c) obtaining a cross-linked and optionally beaded resin according to claim 1 or the composition according to claim 18.

20. The polymerisation process according to claim 19, wherein mixture of alkoxylated reactive compounds are mixed with an initiator in specific ratios, optionally in a solvent and under beading conditions.

21. The polymerisation process according to claim 20, wherein the mixture of alkoxylated reactive compounds is mixed with a solvent to form a dispersed phase and subsequently poured into a continuous phase with stirring.

22. The polymerisation process according to claim 19, wherein the polymer matrix is in a beaded form and obtained by inverse suspension or inverse emulsion polymerisation.
